(19) United States
(12) Patent Application Publication
(10) Pub. No.: US 2007/0131777 A1
(43) Pub. Date: Jun. 14, 2007

(54) CHIP CARD RETAINING MECHANISM

(75) Inventors: Qing Yang, Shenzhen (CN); Chia-Hua Chen, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: SHENZHEN FUTAIHONG PRECISION INDUSTRIAL CO,. LTD, ShenZhen (CN); SUTECH TRADING LIMITED, Tortola (VG)

(21) Appl. No.: 11/309,570

(22) Filed: Aug. 24, 2006

(30) Foreign Application Priority Data
Dec. 9, 2005 (CN) 200510102294.X

(51) Int. Cl. G06K 7/00; G06K 7/06

(52) U.S. Cl. 235/486; 235/441

(57) ABSTRACT

A chip card retaining mechanism for retaining a chip card (40) mounted in an electronic device, the electronic device including a housing (10). The chip card retaining mechanism includes a receiving portion (20), and a locking assembly (30). The receiving is formed on the housing for fittingly receiving the chip card therein. The receiving portion has an open end facing the battery compartment of the electronic device. The locking assembly includes a first stopper mechanism (32) and a second stopper mechanism (34). The first stopper mechanism includes a pair of wings (322) extending from two opposite sides of the receiving portion over the receiving portion and a second wings (324) extending from one end of the receiving portion and spanning over the receiving portion. The second stopper mechanism is configured for restricting the chip card moving out of the receiving portion along a horizontal direction.

### 1. FIELD OF THE INVENTION

The present invention generally relates to chip card retaining mechanisms and, more particularly, to a chip card retaining mechanism for seating a chip card in an electronic device such as a mobile phone.

### 2. DESCRIPTION OF RELATED ART

Nowadays, electronic devices such as mobile phones are widely used and bring convenience to our lives, as such, electronic devices have become a part of modern life. Every electronic device has a chip card such as a SIM (subscriber identification module) card for carrying information necessary for operating the mobile phone. The chip card may also contain personal information for the subscriber, for example, a listing of frequently used telephone numbers. However, it is necessary to provide a chip card retaining mechanism to hold the chip card in the electronic device.

Referring to FIG. 5, a typical chip card retaining mechanism used in a mobile phone is as follows. The chip card retaining mechanism includes a mounting base 52 and a locking element 54. A receiving groove 520 is defined in the mounting base 52 for receiving a chip card. A connector 50 is disposed in the receiving groove 520. The locking element 54 is mounted on the mounting base 52 and located adjacent to the receiving groove 520. The locking element 54 can move in a direction shown by an arrow. In assembly, the locking element 54 is pushed away from the receiving groove 520 to completely expose the receiving groove 520. A SIM card is received in the receiving groove 520, and the locking element 54 is pushed toward the receiving groove 520 to cover a portion of the receiving groove 520 so that the SIM card cannot be removed from the receiving groove 520.

Although the locking element 54 can be easily moved to assemble the SIM card, when a mobile phone inadvertently undergoes impact, this impact may result in an outer force which removes the locking element 54 from the receiving groove 520, which can result in an ineffective electrical connection between the SIM card and the connector 50. At worst, the SIM card may become completely separated from the receiving groove 520, which badly affects stability of the mobile phone.

What is needed, therefore, is a chip card retaining mechanism, which overcomes the above-described shortcomings.

### SUMMARY OF THE INVENTION

In a first preferred embodiment, a chip card retaining mechanism for retaining a chip card mounted in an electronic device which includes a housing. The chip card retaining mechanism includes a receiving portion, and a locking assembly. The receiving portion is formed on the housing for fittingly receiving the chip card therein. The receiving portion has an open end facing the battery compartment of the electronic device. The locking assembly includes a first stopper mechanism and a second stopper mechanism. The first stopper mechanism includes a pair of wings extending from two opposite sides of the receiving portion over the receiving portion, and a second wings extending from one end of the receiving portion and spanning over the receiving portion. The second stopper mechanism is configured for restricting movement of the chip card out of the receiving portion along a horizontal direction.

Other advantages and novel features of the preferred embodiments of the present chip card retaining mechanism and its applications will become more apparent from the following detailed description when taken in conjunction with the accompanying drawings.

### BRIEF DESCRIPTION OF THE DRAWINGS

Many aspects of the present chip card retaining mechanisms and their applications can be better understood with reference to the following drawings. The components in the drawings are not necessarily drawn to scale, the emphasis instead being placed upon clearly illustrating the principles of the chip card retaining mechanisms. Moreover, in the drawings, like reference numerals designate corresponding parts throughout the several views.

FIG. 1 is an isometric view of an electronic device, which employs a chip card retaining mechanism in accordance with a preferred embodiment;

FIG. 2 is an exploded, isometric view of the chip card retaining mechanism of the preferred embodiment;

FIG. 3 is an assembled, isometric view of the chip card retaining mechanism of FIG. 2, showing the chip card in an un-assembled state;

FIG. 4 is an assembled, isometric view of the chip card retaining mechanism of FIG. 2, showing the chip card assembled;

FIG. 5 is an cross-sectional view taken along V-V line of FIG. 3, showing a first position of the chip card; and

FIG. 5 is an exploded, isometric view of a typical chip card retaining mechanism.

### DETAILED DESCRIPTION OF THE INVENTION

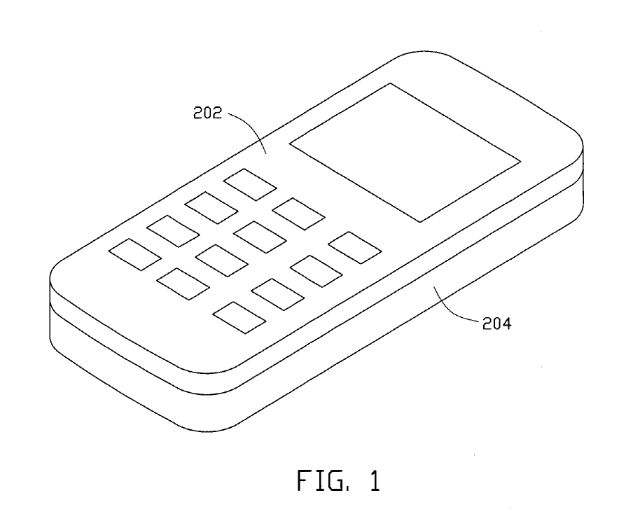

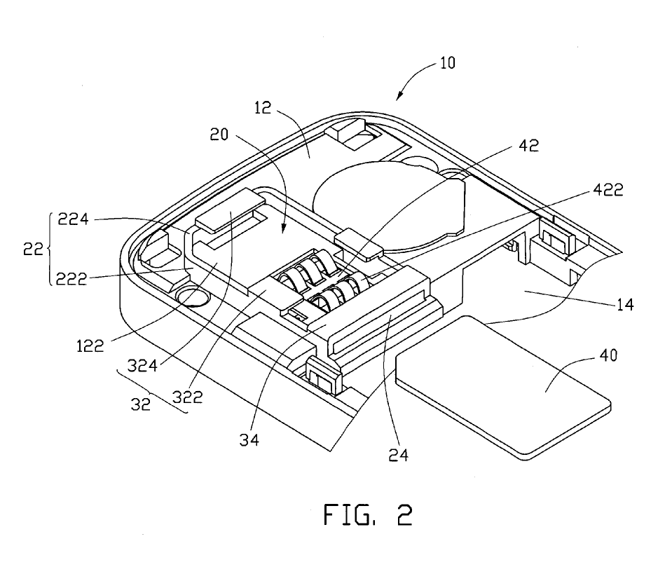

A chip card retaining mechanism is adapted for retaining a chip card in an electronic device such that the chip card is electronically connected with a connector in the electronic device. Referring to FIG. 1, the chip card retaining mechanism is applied to an exemplary mobile phone 200, which includes a front cover 202, a housing 10, and a rear cover 204. The front cover 202 and the rear cover 204 cooperatively define an enclosed space. The housing 10 is mounted in the enclosed space. Referring to FIG. 2, in order to identify the used mobile phone, when communicating, a chip card 40, such as a subscriber identification module, also called SIM card, is provided. Referring to FIG. 2, in the figure parts of the housing 10 have been omitted for reasons of clarity. The housing 10 has a battery compartment 14 defined adjacent to a partition 12 of the housing 10. The battery compartment 14 is for receiving a battery (not shown).

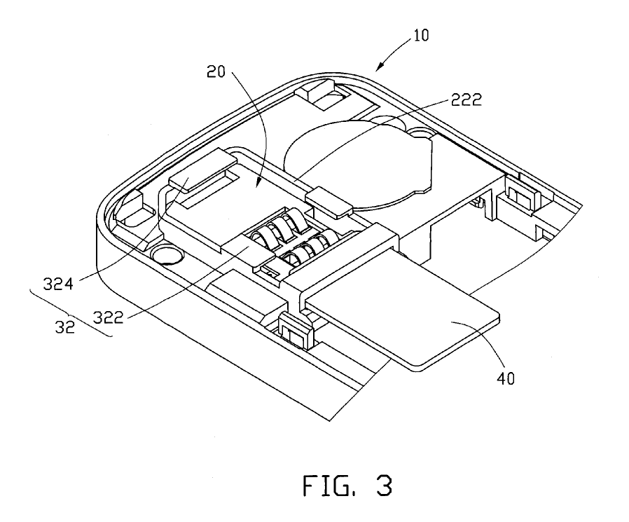

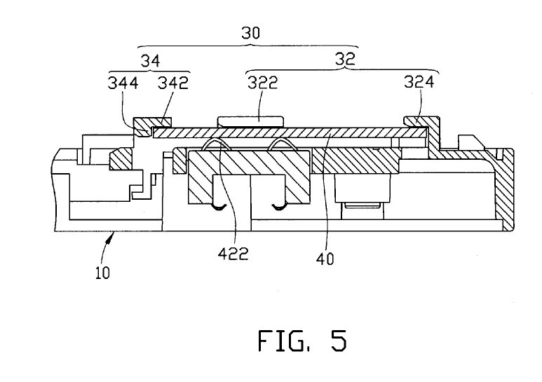

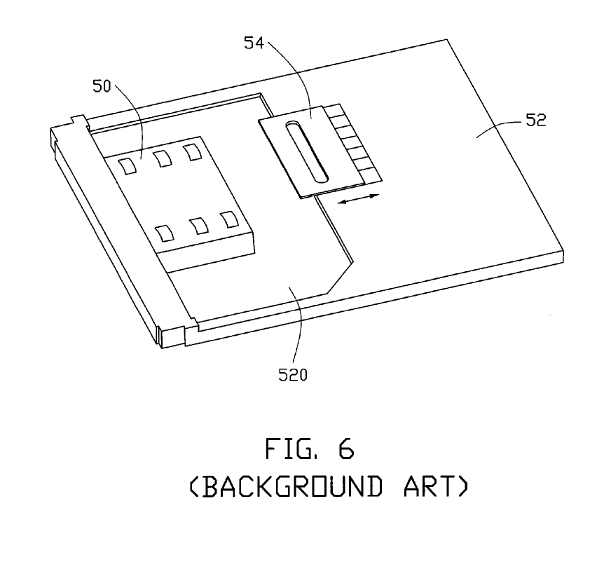

Referring to FIGS. 3-5, the chip card retaining mechanism includes a receiving portion 20, and a locking assembly 30 (referring to FIG. 5). The receiving portion 20 is configured for receiving the chip card 40.

The receiving portion 20 is disposed adjacent to the battery compartment 14. The receiving portion 20 is substantially rectangular, and shape and size of the receiving portion 20 corresponds to the chip card 40. The receiving portion 20 is formed by an upper surface 122 of the partition 12, and a strip 22. The strip 22 includes a pair of side portions 222 parallel to each other, and an end portion 224 connecting to each of side portion 222. The end portion 224 is arranged to be adjacent to a peripheral edge of the housing 10 and away from the battery compartment 14. The receiving portion 20 has an open end 24 facing the battery compartment, for insertion or withdrawl of the chip card 40. The open end 24 is arranged to face the battery compartment 14.

The chip card 40 carries information that is necessary for operating the telephone and personal information of the owner and may be an integrated circuit card. The chip card 40 is electrically connected to a printed circuit board (PCB, not shown) by a connector 42. The connector 42 is secured in the housing 10 and disposed in a middle of the receiving portion 20. The connector 42 has a plurality of elastic contacts 422. The elastic contacts 422 protrude from an upper surface 122 of the partition 12. The chip card 40 is mounted in the receiving portion 20 in contact with the elastic contacts 422 of the connector 42.

Referring also to FIG. 5, the locking assembly 30 includes a first stopper mechanism 32 and a second stopper mechanism 34. The first stopper mechanism 32 is configured for restricting the chip card 40 moving out of the receiving portion 20 along a vertical direction. The second stopper mechanism 34 is configured so as to restrict movement of the chip card out of the receiving portion 20 along a horizontal direction. The first stopper mechanism 32 includes a pair of first wings 322, and a second wing 324. The first wings 322 extend from the pair of side portions 222 toward each other, and are spaced apart from the second wing 324. The second wing 324 extends from the end portion 224 toward the receiving portion 20. The second stopper mechanism 34 includes a plate 342 extending from one distal end of one side portion 224 to one distal end of another side portion 224, and a block 344 vertically extending from the plate 342 downward to the extent that a distance between the block 344 and a bottom of the receiving portion 20 is larger than a width of the chip card 40. The plate 342 is configured for spanning over the receiving portion 20. Thus, the first stopper mechanism 32 and the second stopper mechanism 34 are both integrally formed with the housing 10.

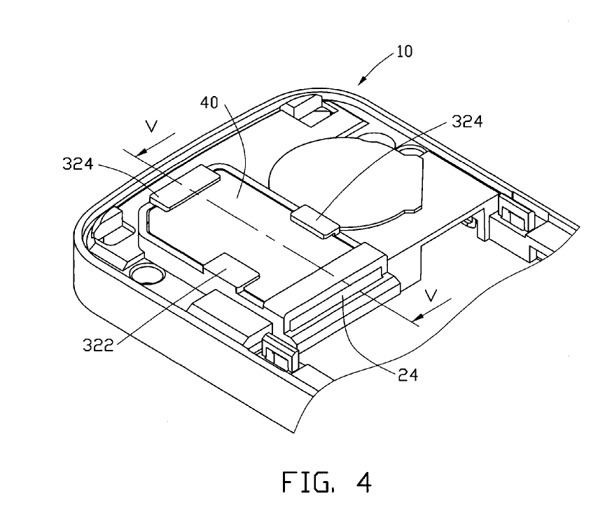

Referring to FIGS. 3-4, in assembling and mounting the chip card 40, the chip card 40 is pushed into the receiving portion 20 via the open end 24 and slides in the receiving portion 20 under the guidance of the side portion 222, with the elastic contacts 422 of the connector 42 elastically abutting a first surface of the chip card 40. When the chip card 40 is completely contained in the receiving portion 20, and a first end of the chip card 40 abuts the end portion 224, the chip card 40 is lifted up under an elastic force of the elastic contacts 422 of the connector 42, with an opposite second end of the chip card 40 abutting the block 344 and an opposite second surface of the chip card 40 abutting the wings 322, 324 and the plate 342. Thus, the chip card 40 is stably locked in the receiving portion 20, both by the stopper mechanism 32 in a vertical direction, and by the second stopper mechanism 34 in a horizontal direction, thus preventing accidental separation from the receiving portion 20. Therefore, an effective electrical connection between the chip card 50 and the connector 52 is provided.

When removing the chip card 40, the chip card 40 is pressed downward to align with the open end 24 of the receiving portion 20. The chip card 40 is pushed out of the receiving portion via the open end 24. As such, the chip card 40 can be removed from the housing 10.

In an alternative embodiment, the second wing 324 may be omitted.

In a further alternative embodiment, the receiving portion 20 may be recessed from the upper surface 122 of the partition 12, thus the strip 22 may be omitted.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A chip card retaining mechanism for retaining a chip card mounted in an electronic device, the electronic device including a housing, the housing having a battery compartment defined therein, the chip card retaining mechanism comprising:
a receiving portion formed on the housing for receiving the chip card therein, the receiving portion having an open end facing the battery compartment of the electronic device; and
a locking assembly, the locking assembly including a first stopper mechanism and a second stopper mechanism, the first stopper mechanism including a pair of wings extending from two opposite sides of the receiving portion over the receiving portion and a second wings extending from one end of the receiving portion and spanning over the receiving portion, the second stopper mechanism configured for restricting movement of the chip card out of the receiving portion along a horizontal direction.

2. The chip card retaining mechanism as claimed in claim 1, wherein the second stopper mechanism includes a block disposed adjacent to the open end of the receiving portion and spaced apart from a bottom of the receiving portion such that the chip card can be pushed into the receiving portion via the open end.

3. The chip card retaining mechanism as claimed in claim 2, wherein the second stopper mechanism further includes a plate spanning over the receiving portion, and the block extends downwards from the plate.

4. The chip card retaining mechanism as claimed in claim 1, wherein the receiving portion is a receiving groove defined by a strip protruding from a surface of the housing.

5. The chip card retaining mechanism as claimed in claim 1, wherein the receiving portion is a receiving groove recessed from a surface of the housing.

6. A chip card retaining mechanism for retaining a chip card mounted in an electronic device, the electronic device including a housing, the chip card retaining mechanism comprising:
a receiving portion formed on the housing for receiving the chip card therein, the receiving portion having an open end facing the battery compartment of the electronic device; and
a locking assembly, the locking assembly including at least two first wings extending from sides of the receiving portion, and a block disposed adjacent to the open end for limiting movement of the chip card of the receiving portion via the open end.

7. The chip card retaining mechanism as claimed in claim 6, wherein the receiving portion is a receiving groove defined by a strip protruding from a surface of the housing.

8. The chip card retaining mechanism as claimed in claim 7, wherein the strip includes a pair of side portions, and the at least wings extend from the side portions.

9. The chip card retaining mechanism as claimed in claim 7, wherein the strip further includes an end portion opposite to the open end, and the locking assembly further comprises a second extending from the end portion over the receiving portion.

10. The chip card retaining mechanism as claimed in claim 6, wherein the locking assembly further includes a plate spanning over the receiving portion, and the block extends from the plate downward and is spaced apart from a bottom of the receiving portion such that the chip card can be pushed into the receiving portion via the open end.

11. The chip card retaining mechanism as claimed in claim 6, wherein the receiving portion is a receiving groove recessed from a surface of the housing.

12. The chip card retaining mechanism as claimed in claim 6, further comprising a connector, and the connector having a plurality of elastic electrical contacts elastically abutting the chip card.
